(19) United States
(12) Patent Application Publication
(10) Pub. No.: US 2024/0087108 A1
(43) Pub. Date: Mar. 14, 2024

(54) METHODS FOR BUILDING RETROFIT ANALYSIS AND VERIFICATION

(71) Applicant: Signetron Inc., Berkeley, CA (US)

(72) Inventors: Avideh Zakhor, Berkeley, CA (US); Zixian Zang, Berkeley, CA (US); Matthew Garrett Ming-Lee Tang, Irvine, CA (US)

(21) Appl. No.: 17/941,488

(22) Filed: Sep. 9, 2022

(51) Int. Cl. G06T 7/00; G01J 5/48; G06T 7/13; G06T 7/70; G06T 15/04; G06T 15/20; G06T 17/05

(52) U.S. Cl. CPC G06T 7/001; G01J 5/48; G06T 7/13; G06T 7/70; G06T 15/04; G06T 15/205; G06T 17/05; G01J 2005/0077; G06T 2207/10024; G06T 2207/10032; G06T 2207/10048; G06T 2207/30108; G06T 2207/30184; G06T 2210/04

(57) ABSTRACT

Methods of retrofit analysis and verification for a building are presented including: analyzing a pre-retrofitted building; performing a retrofit on the pre-retrofitted building; and verifying the post-retrofitted building. In some embodiments, the analyzing the pre-retrofitted building includes: receiving a long view red-green-blue (RGB) stream of the pre-retrofitted building and storing to an RGB image repository; creating an RGB panorama of the pre-retrofitted building; receiving a close view RGB stream of the pre-retrofitted building and storing to the RGB image repository; receiving a close view pre-retrofit infrared (IR) thermography stream of the pre-retrofitted building and storing to a pre-retrofit IR image repository; and identifying pre-retrofit anomalies of the pre-retrofitted building.

### BACKGROUND

Infrared thermography is typically used to detect the three main culprits in envelope retrofit: thermal bridging, air infiltration, and insulation deficiencies. This is typically done by having a human operator use a thermal camera to simultaneously capture IR images and visually detect anomalies real time as s/he walks around the perimeter of the building. There are multiple problems associated with the current practice: first for buildings with more than one story, the resulting IR images cannot properly capture higher stories. Second, the approach is error prone in that the human operator can potentially miss thermal anomalies due to real time cognitive overload on the spot. Third, the process is laborious and takes a long time since each time a defect is detected, the operator has to stop and mark the location of the defect in construction drawings or use imprecise or excessive words to identify the exact location of the defect. This is further complicated when comparing pictures of the same spot on the building pre and post retrofit.

As such, methods for building retrofit analysis and verification are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, methods of retrofit analysis and verification for a building are presented including: analyzing a pre-retrofitted building; performing a retrofit on the pre-retrofitted building; and verifying the post-retrofitted building. In some embodiments, the analyzing the pre-retrofitted building includes: receiving a long view red-green-blue (RGB) stream of the pre-retrofitted building and storing to an RGB image repository; creating an RGB panorama of the pre-retrofitted building; receiving a close view RGB stream of the pre-retrofitted building and storing to the RGB image repository; receiving a close view pre-retrofit infrared (IR) thermography stream of the pre-retrofitted building and storing to a pre-retrofit IR image repository; and identifying pre-retrofit anomalies of the pre-retrofitted building. In some embodiments, the identifying the pre-retrofit anomalies includes: selecting a point on the RGB panorama; recovering a close view RGB image corresponding with the selected point from the RGB image repository, where the close view RGB image is recovered using RGB image global positioning system (GPS) and pose metadata; and recovering a close view pre-retrofit IR image corresponding with the selected point from the pre-retrofit IR image repository, where the close view pre-retrofit IR image is recovered using close view pre-retrofit IR image GPS and pose metadata; and displaying the close view RGB image and the close view pre-retrofit IR image corresponding with the selected point. In some embodiments, methods further include: superimposing the close view pre-retrofit IR image on the RGB panorama. In some embodiments, the superimposing the close view pre-retrofit IR image on the RGB panorama includes: undistorting the close view pre-retrofit IR image; selecting a number of close view pre-retrofit IR image correspondence points on the close view pre-retrofit IR image; selecting a number of RGB panorama correspondence points on the RGB panorama corresponding with the number of close view pre-retrofit IR image correspondence points; calculating a projected transformation between the close view pre-retrofit IR image and the RGB panorama such that pixels between the close view pre-retrofit IR image and the RGB panorama in the projected transformation are paired; and replacing each paired RGB panorama pixel in the RGB panorama with a corresponding close view pre-retrofit IR image pixel in the projected transformation. In some embodiments, the verifying the post-retrofitted building includes: receiving a close view post-retrofit IR thermography stream of the post-retrofitted building and storing to a post-retrofit IR image repository; and identifying the post-retrofit anomalies. In some embodiments, the identifying the post-retrofit anomalies includes: recovering a close view post-retrofit IR image corresponding with the selected point from the post-retrofit IR image repository, where the close view post-retrofit IR image is recovered using close view post-retrofit IR image GPS and pose metadata; and displaying the close view RGB image, the close view pre-retrofit IR image, and the close view post-retrofit IR image; and comparing the close view pre-retrofit IR image and the close view post-retrofit IR image to verify the post-retrofitted building. In some embodiments, methods further include: superimposing the close view post-retrofit IR image on the RGB panorama. In some embodiments, the superimposing the post-retrofit IR image on the RGB panorama includes: undistorting the close view post-retrofit IR image; selecting a number of close view post-retrofit IR image correspondence points on the close view post-retrofit IR image; selecting a number of RGB panorama correspondence points on the RGB panorama corresponding with the number of close view post-retrofit IR image correspondence points; calculating a projected transformation between the close view post-retrofit IR image and the RGB panorama such that pixels between the close view post-retrofit IR image and the RGB panorama in the projected transformation are paired; and replacing each paired RGB panorama pixel in the RGB panorama with a corresponding close view post-retrofit IR image pixel in the projected transformation.

In some embodiments, the recovering the close view RGB image, the close view pre-retrofit IR image, and the close view post-retrofit includes: selecting a number of façade corners that define a facade on the RGB panorama; finding a number of façade endpoints corresponding with at least two of the number of façade corners on a digital map; finding global positioning system (GPS) of the number of façade endpoints; estimating a building height; computing an equation of a façade plane; projecting all close view RGB images, all close view pre-retrofit IR images, and all close view post-retrofit images on the façade plane; computing pixel coordinates of the projected image corners of all projected images; computing pixel coordinate of center of all projected images; and displaying projected images having the pixel coordinate of center that substantially matches the selected point. In some embodiments, the RGB stream is captured by a first drone having a first flight path; the close view pre-retrofit IR thermography stream is captured by a second drone having a second flight path; and the close view RGB stream is captured by a third drone having a third flight path. In some embodiments, the close view RGB stream and the close view pre-retrofit IR thermography stream are captured by the second drone on the second flight path. In some embodiments, the close view post-retrofit IR thermography stream is captured by a fourth drone having a fourth flight path. In some embodiments, the analyzing the pre-retrofitted building includes: receiving an RGB stream of the pre-retrofitted building and storing to an RGB image repository; creating a 3D building model of the pre-retrofitted building using the RGB stream; receiving a pre-retrofit IR thermography stream of the pre-retrofitted building and storing to a pre-retrofit IR image repository; texture mapping the 3D building model with pre-retrofit IR images using GPS and pose metadata corresponding with the pre-retrofit IR images; and identifying pre-retrofit anomalies of the pre-retrofitted building. In some embodiments, the identifying the pre-retrofit anomalies includes: selecting a point or an area on the 3D building model; and displaying the pre-retrofit IR image corresponding with the point or area of the 3D model. In some embodiments, the verifying the post-retrofitted building includes: receiving a post-retrofit IR thermography stream of the post-retrofitted building and storing to a post-retrofit IR image repository; texture mapping the 3D building model with post-retrofit IR images using GPS and pose metadata corresponding with the post-retrofit IR images; and identifying post-retrofit anomalies of the post-retrofitted building. In some embodiments, the identifying the post-retrofit anomalies includes: displaying the RGB image, the pre-retrofit IR image, and the post-retrofit IR image corresponding with the point or area of the 3D; and comparing the pre-retrofit IR image and the post-retrofit IR image to verify the post-retrofitted building. In some embodiments, the RGB stream is captured by a first drone having a first flight path; and the pre-retrofit IR thermography stream is captured by a second drone having a second flight path. In some embodiments, the RGB stream and the pre-retrofit IR thermography stream are captured by a first drone having a first flight path. In some embodiments, the post-retrofit IR thermography stream is captured by a third drone having a third flight path.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative flowchart of methods for building retrofit analysis and verification in accordance with embodiments of the present invention;

FIG. 2 is an illustrative flowchart of methods for pre-retrofit analysis in accordance with embodiments of the present invention;

FIG. 3 is an illustrative flowchart of methods for post-retrofit verification in accordance with embodiments of the present invention;

FIGS. 4A and 4B are illustrative flowcharts of methods for identifying anomalies in accordance with embodiments of the present invention;

FIG. 5 is an illustrative flowchart of methods for superimposing IR images on a panorama in accordance with embodiments of the present invention;

FIG. 6 is an illustrative flowchart of methods for pre-retrofit analysis in accordance with embodiments of the present invention;

FIG. 7 is an illustrative flowchart of methods for post-retrofit verification in accordance with embodiments of the present invention;

FIG. 8 is an illustrative flowchart of methods for recovering images in accordance with embodiments of the present invention;

FIG. 9 is an illustrative representation of retrofit analysis and verification in accordance with embodiments of the present invention;

FIG. 10 is an illustrative representation of superimposition in accordance with embodiments of the present invention;

FIG. 11 are illustrative representations of retrofit analysis and verification in accordance with embodiments of the present invention;

FIG. 12 is an illustrative representation of a building façade in accordance with embodiments of the present invention;

FIG. 13 is an illustrative representation of finding endpoints on a digital map in accordance with embodiments of the present invention; and

FIG. 14, which is an illustrative representation of a projected area on a façade in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

As will be appreciated by one skilled in the art, the present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals /per se/, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In still other instances, specific numeric references such as “first material,” may be made. However, the specific numeric reference should not be interpreted as a literal sequential order but rather interpreted that the “first material” is different than a “second material.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

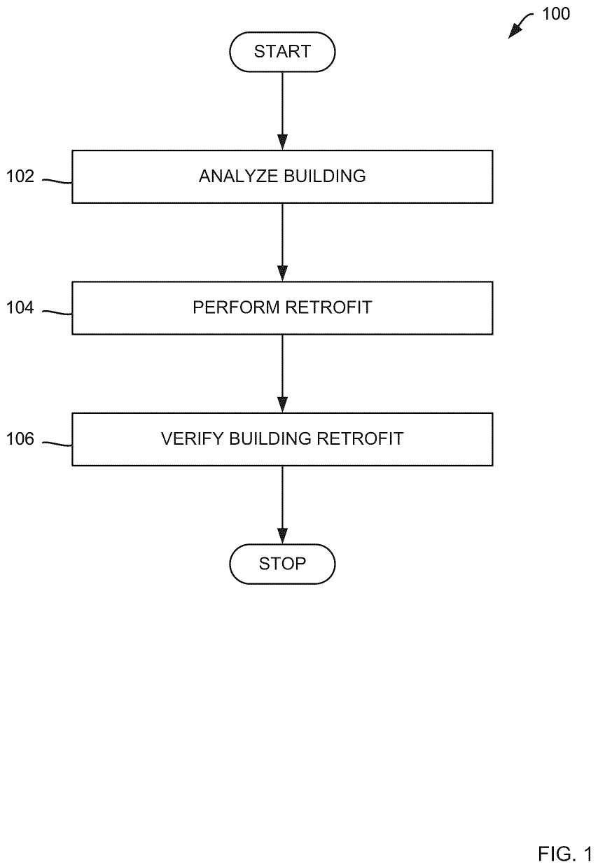

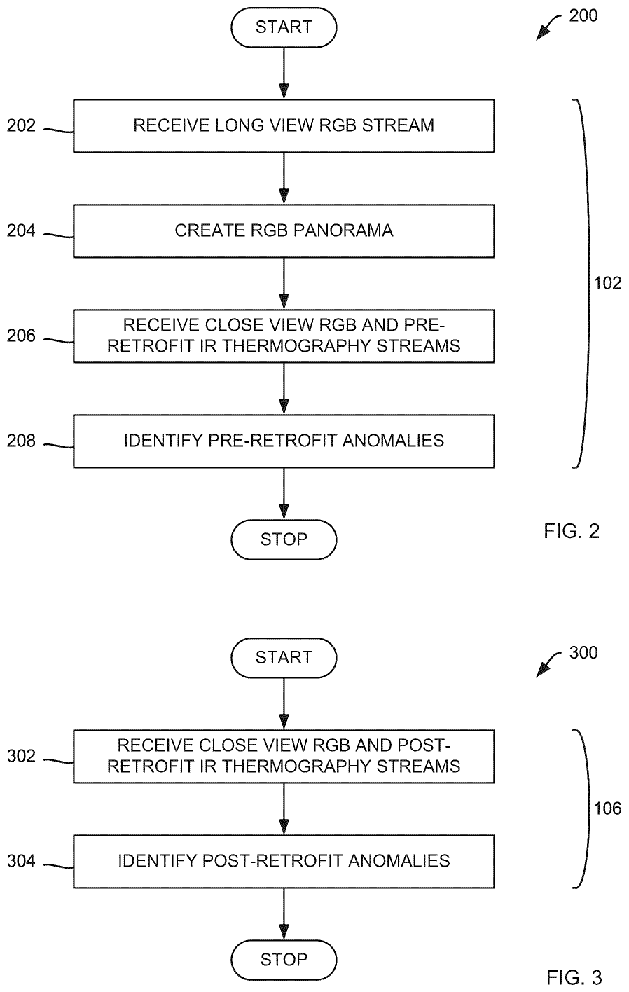

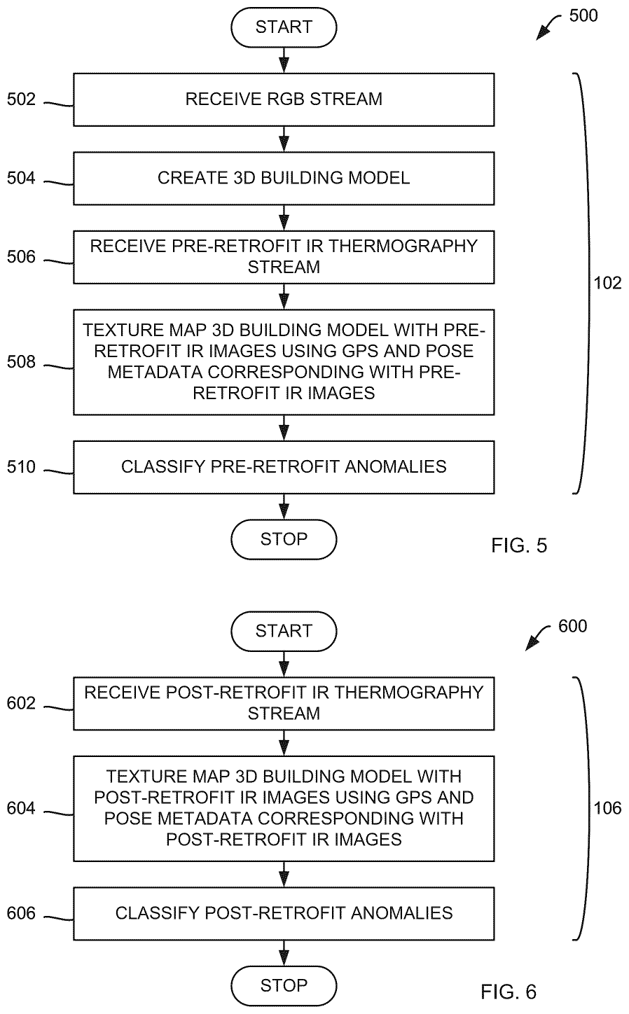

FIG. 1 is an illustrative flowchart 100 of methods for building retrofit analysis and verification in accordance with embodiments of the present invention. As such, at a first step 102, the method analyzes a pre-retrofitted building. As contemplated herein, analysis of a pre-retrofitted building proceeds from externally captured images of the building. These externally captured images include both red-green-blue (RGB) images and infrared (IR) images. In conventional methods, analysis of pre-retrofitted buildings is accomplished by examining building plans and comparing the building plans with on-site inspections. Methods disclosed herein do not rely on either building plans, which may deviate from what is actually built, or on-site inspections, which can be costly and highly subjective. Analyzing pre-retrofitted buildings will be discussed in further detail below for FIGS. 2 and 5. At a next step, 104, a retrofit is performed. In embodiments, retrofitting may include any envelope retrofit operation known in the art without departing from embodiments here such as: replacing windows and doors; removing and replacing insulation; replacing external cladding of the building; and the like. At a next step 106, the method verifies a post-retrofitted building. Often, verification of building retrofits can only be inferred from the operational conditions of the building. For example, if a retro-fitted building's power consumption is reduced, it might be inferred that retro-fitted insulation was both completed and effective. Methods disclosed herein provide more direct verification of a post-retrofitted building. Verification will be discussed in further detail below for FIGS. 3 and 6.

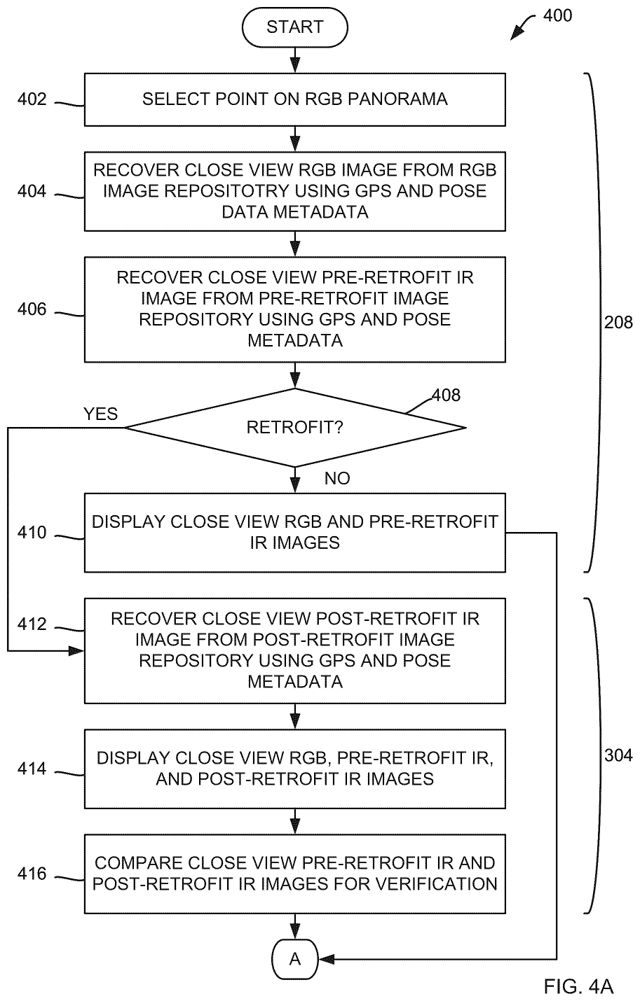

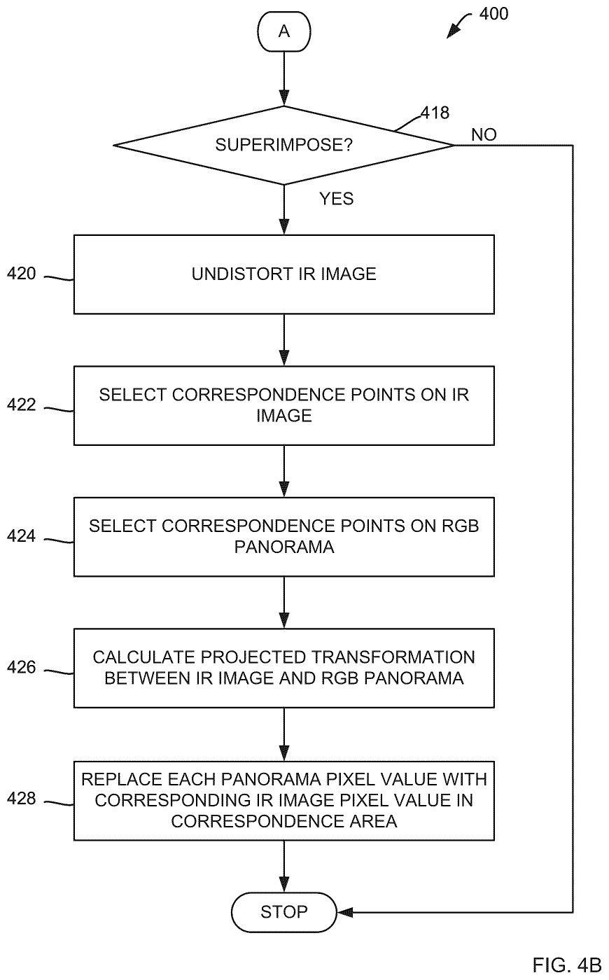

FIG. 2 is an illustrative flowchart 200 of methods for pre-retrofit analysis in accordance with embodiments of the present invention. In particular, flowchart 200 further clarifies a step 102 (see FIG. 1). At a first step 202, the method receives a long view RGB stream of a pre-retrofitted building. Long view RGB streams may be collected from any number of sources without limitation and without departing from embodiments disclosed herein. Typically, a long view RGB stream is collected by a drone, which may be programmed to follow a desired flight path or may be flown by remote control. Long view RGB streams may be stored to an RGB image repository. In embodiments, long view RGB images contain metadata such as global positioning system (GPS) data and camera orientation data. The terms “long view” and “close view” as utilized herein correspond with the relative positions of a capture device from a building under inspection and should not otherwise be construed as limiting. As such, a “long view” image is an image capturing a large portion of a building whereas a “close view” is an image capturing a smaller portion of a building. At a next step 204, the method creates an RGB panorama of the building utilizing long view RGB images. A panorama presents a continuous representation of the building for a user. In embodiments, for a facade under consideration, there should preferably be at least 30% overlap between successive long view RGB images to create a reasonable panorama. At a next step 206, the method receives a close view RGB and close view pre-retrofit IR thermography streams. In some embodiments, the close view pre-retrofit IR thermography stream is captured simultaneously with the close view RGB stream utilizing a single drone. In other embodiments, the close view pre-retrofit IR thermography stream is captured separately from the close view RGB stream. As above, a close view pre-retrofit IR thermography stream may be collected by a drone, which may be programmed to follow a desired flight path or may be flown by remote control. Additionally, the close view RGB stream may be stored to the RGB image repository and the close view pre-retrofit IR thermography stream may be stored to a pre-retrofit IR thermography image repository. At a next step 208, the method identifies pre-retrofit anomalies, which step is discussed in further detail below for FIGS. 4A and 4B.

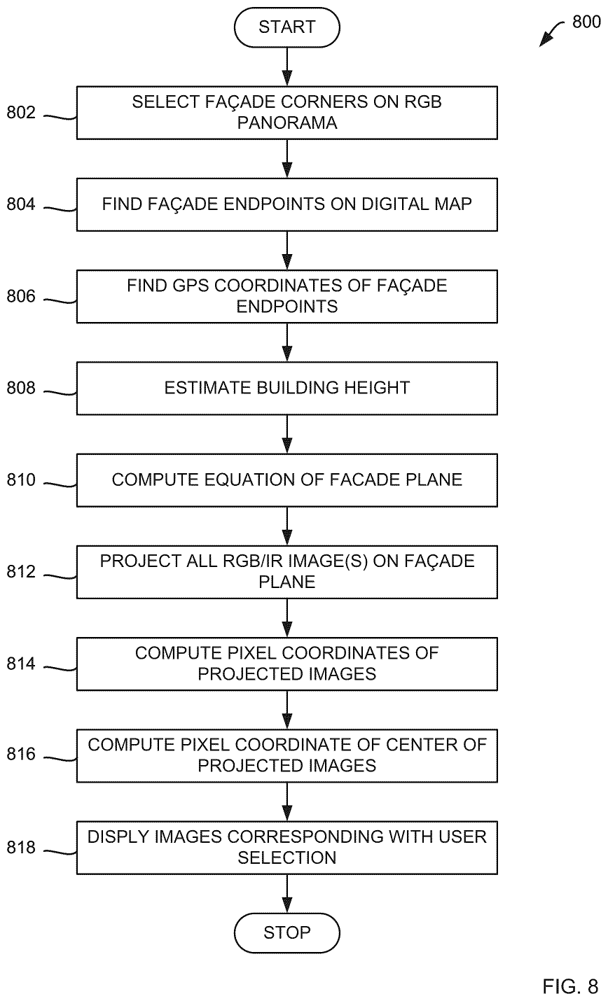

Turning to FIG. 4A, flowchart 400 of methods for identifying anomalies in accordance with embodiments of the present invention is illustrated. In particular, steps 402 to 410 further clarify a step 208 (see FIG. 2). In general, the identifying of anomalies is made possible by correlating the panorama of a building with the IR thermographic images of the same building. As such, at a first step 402, the method selects a point of interest on the RGB panorama. In embodiments, this may be accomplished by a user clicking on a visually displayed RGB panorama. At a next step 404, the method recovers one or more close view RGB images corresponding with the selected point of interest from the RGB image repository. As noted above, close view RGB images contain metadata such as GPS data and camera orientation data. Image recovery will be discussed in further detail below for FIG. 8. At a next step 406, the method recovers one or more close view pre-retrofit IR images from the pre-retrofit IR image repository that correspond with the selected point of interest. Like close view RGB images, close view pre-retrofit IR images contain metadata such as GPS data and camera orientation data. As such, the method selects all close view pre-retrofit IR images that correspond with close view RGB image metadata of the selected point of interest. In some embodiments, a number of close view pre-retrofit IR images may be returned whereupon a “best view” close view pre-retrofit IR image may be selected for display. Image recovery will be discussed in further detail below for FIG. 8. At a next step 408, the method determines whether a retrofit has occurred. If the method determines at a step 408 that a retrofit has not occurred, the method continues to a step 410 to display the RGB image and the pre-retrofit IR image corresponding with the selected point of interest.

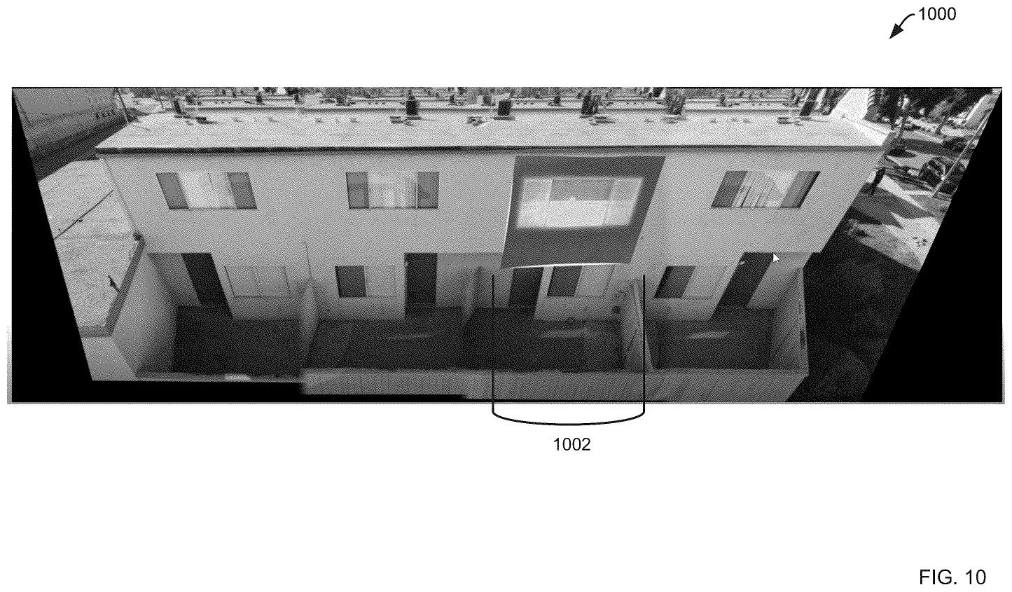

In some embodiments, methods may superimpose the pre-retrofit IR image on the RGB panorama. FIG. 4B is an illustrative flowchart 400 of methods for identifying anomalies in accordance with embodiments of the present invention is illustrated. In particular, FIG. 4B illustrates methods for superimposing a close view pre-retrofit IR image on an RGB panorama. As such, at a first step 418, the method determines whether to superimpose a close view pre-retrofit IR image on an RGB panorama. If the method determines not to superimpose a close view pre-retrofit IR image on an RGB panorama, the method ends. If the method determines to superimpose a close view pre-retrofit IR image on an RGB panorama, the method continues to a step 420 to undistort the close view pre-retrofit IR image. Close view pre-retrofit IR images are undistorted to better “fit” the RGB panorama. At a next step 422, the method selects a number of close view pre-retrofit IR image correspondence points on the close view pre-retrofit IR image—typically four or more points. Correspondence points are points on the close view pre-retrofit IR image that may be easily identified on the RGB panorama. For example, the four points of a window frame may be selected on the close view pre-retrofit IR image. At a next step 424, the method selects a number of RGB panorama correspondence points on the RGB panorama matching the number of close view pre-retrofit IR image correspondence points. Returning to the example, the four points of the pre-retrofit IR image window frame may be matched with corresponding four points on the RGB panorama. In this manner, the areas of interest are matched or paired. At a next step 426, the method calculates a projected transformation between the close view pre-retrofit IR image and the RGB panorama such that pixels between the close view pre-retrofit IR image and the RGB panorama in the projected transformation are paired, whereupon the method replaces each paired RGB panorama pixel in the RGB panorama with a corresponding close view pre-retrofit IR image pixel in the projected transformation at a step 428. The resulting image includes the RGB panorama with a portion of the panorama replaced by the close view pre-retrofit IR image. In this manner a user can easily identify location and condition of the selected point of interest. Turning briefly to FIG. 10, an illustrative representation of panorama 1000 having a superimposed IR image 1002 is shown for clarity in understanding embodiments of the present invention. The method then ends. It may be noted that steps 418 to 428 are applicable to both close view pre-retrofit IR images and close view post-retrofit IR images in embodiments.

Turning to FIG. 3, FIG. 3 is an illustrative flowchart 300 of methods for post-retrofit verification in accordance with embodiments of the present invention. In particular, flowchart 300 further clarifies a step 106 (see FIG. 1). At a first step 302 the method receives a close view post-retrofit IR thermography stream. Close view post-retrofit IR thermography streams are collected after a retrofitting operation in order to verify the installation or repair. As above, a close view post-retrofit IR thermography stream may be collected by a drone, which may be programmed to follow a desired flight path or may be flown by remote control. In addition, close view post-retrofit IR thermography streams may be stored to a post-retrofit IR thermography image repository. At a next step 304, the method identifies post-retrofit anomalies, which step is discussed in further detail below for FIGS. 4A and 4B.

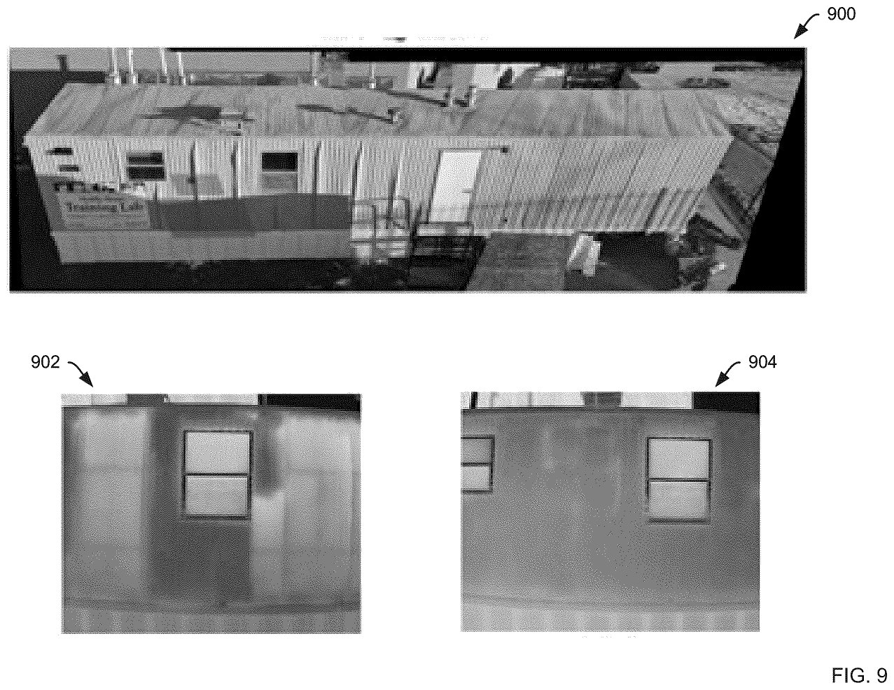

Returning to FIG. 4A, if the method determines at a step 408 that a retrofit has occurred, the method continues to a step 412 to recover one or more close view post-retrofit IR images from the post-retrofit IR image repository that correspond with a selected point of interest. Like close view RGB images, close view post-retrofit IR images contain metadata such as GPS data and camera orientation data. As such, the method selects the close view post-retrofit IR images that correspond with RGB image metadata of the selected point of interest. In some embodiments, a number of close view post-retrofit IR images may be returned whereupon a “best view” post-retrofit IR image may be selected for display. Image recovery will be discussed in further detail below for FIG. 8. At a next step 414, the method displays the close view RGB image, the close view pre-retrofit IR image, and the close view post-retrofit IR image corresponding with the selected point of interest. At a next step 416, the method compares post-retrofit anomalies with pre-retrofit anomalies. In practice, the comparison is typically a visual comparison of the displayed IR thermography images. However, in some embodiments, comparison between the anomalies may proceed algorithmically. Turning briefly to FIG. 9, an illustrative representation of panorama 900, close view pre-retrofit IR image 902, and close view post-retrofit IR image 904 are shown for clarity in understanding embodiments of the present invention. In the example illustrated, the effect of added insulation is clearly shown when comparing the IR images. Conventionally, verification of the retrofit could only have been possible by on-site supervision of the installation or by inferring from power consumption. Utilizing embodiments disclosed herein, verification can be accomplished from external imagery.

In some embodiments, methods may superimpose the close view post-retrofit IR image on the RGB panorama. FIG. 4B is an illustrative flowchart 400 of methods for identifying anomalies in accordance with embodiments of the present invention is illustrated. In particular, FIG. 4B illustrates methods for superimposing a close view post-retrofit IR image on an RGB panorama. As such, at a first step 418, the method determines whether to superimpose a close view post-retrofit IR image on an RGB panorama. If the method determines not to superimpose a close view post-retrofit IR image on an RGB panorama, the method ends. If the method determines to superimpose a close view post-retrofit IR image on an RGB panorama, the method continues to a step 420 to undistort the close view post-retrofit IR image. Close view post-retrofit IR images are undistorted to better “fit” the RGB panorama. At a next step 422, the method selects a number of close view post-retrofit IR image correspondence points on the close view post-retrofit IR image—typically four or more points. Correspondence points are points on the close view post-retrofit IR image that may be easily identified on the RGB panorama. For example, the four points of a window frame may be selected on the close view post-retrofit IR image. At a next step 424, the method selects a number of RGB panorama correspondence points on the RGB panorama matching the number of close view post-retrofit IR image correspondence points. Returning to the example, the four points of the close view post-retrofit IR image window frame are matched with corresponding four points of the RGB panorama. In this manner, the areas of interest are matched. At a next step 426, the method calculates a projected transformation between the close view post-retrofit IR image and the RGB panorama such that pixels between the close view post-retrofit IR image and the RGB panorama in the projected transformation are paired, whereupon the method replaces each paired RGB panorama pixel in the RGB panorama with a corresponding close view post-retrofit IR image pixel in the projected transformation at a step 428. The resulting image includes the RGB panorama with a portion of the panorama replaced by the close view post-retrofit IR image. In this manner a user can easily identify location and condition of the selected point of interest. Turning briefly to FIG. 10, an illustrative representation of panorama 1000 having a superimposed IR image 1002 is shown for clarity in understanding embodiments of the present invention. The method then ends. It may be noted that steps 418 to 428 are applicable to both close view pre-retrofit IR images and close view post-retrofit IR images in embodiments.

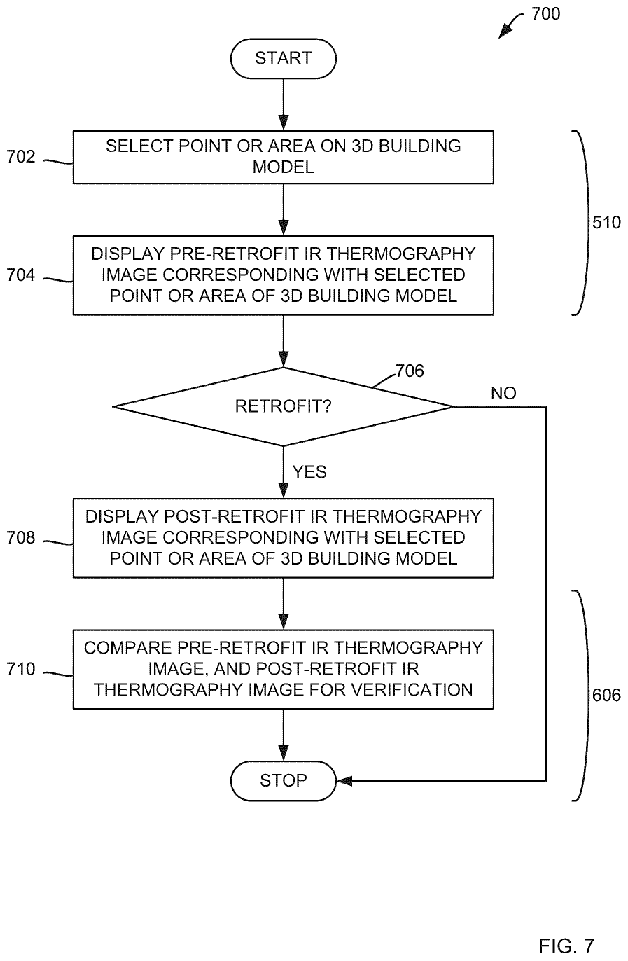

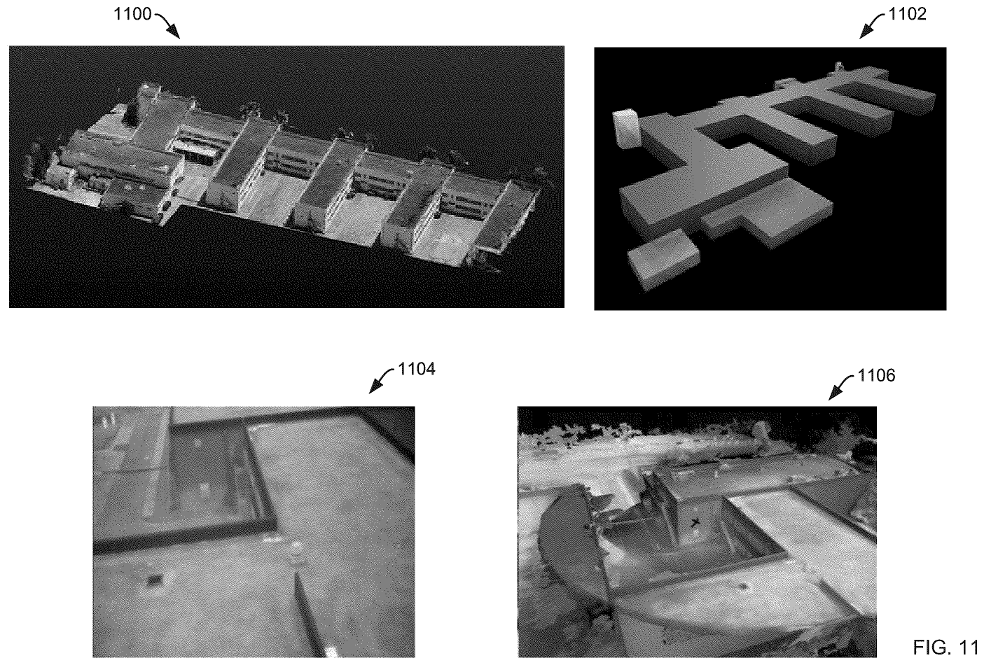

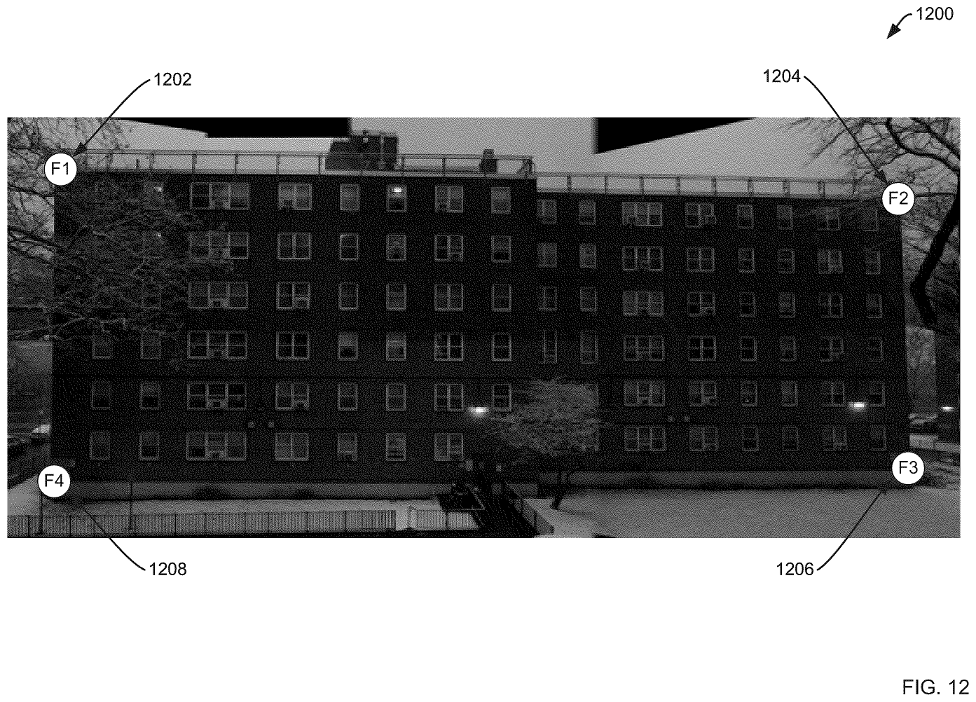

FIG. 5 is an illustrative flowchart 500 of methods for pre-retrofit analysis in accordance with embodiments of the present invention. In some embodiments, it may be desirable to provide other methods of analysis and verification. As such, at a first step 502, the method receives an RGB stream of a pre-retrofitted building. RGB streams may be collected from any number of sources without limitation and without departing from embodiments disclosed herein. Typically, an RGB stream is collected by a drone, which may be programmed to follow a desired flight path or may be flown by remote control. RGB streams may be stored to an RGB image repository. In embodiments, RGB images contain metadata such as global positioning system (GPS) data and camera orientation data. At a next step 504, the method creates a 3D model of the building from the RGB stream. In creating a 3D model of the building, the method first generates a point cloud. Turning to FIG. 11, an illustrative point cloud 1100 from the RGB stream is presented. In general, a point cloud is a set of data points in space generated from images and GPS coordinates associated with the images. The points may represent a 3D shape or object. Each point position has its set of Cartesian coordinates. Point clouds are generally produced by 3D scanners or by photogrammetry software, which measure many points on the external surfaces of objects around them. Once a point cloud has been generated, a 3D model 1102 is created from the point cloud. One benefit of the 3D model is that the model requires considerably less memory space to represent the building. As such, a lightweight representation of the building is created. Returning to FIG. 5, at a next step 506, the method receives a pre-retrofit IR thermography stream. In some embodiments, the pre-retrofit IR thermography stream is captured simultaneously as the RGB stream utilizing a single drone. In other embodiments, the pre-retrofit IR thermography stream is captured separately from the RGB stream. As above, a pre-retrofit IR thermography stream may be collected by a drone, which may be programmed to follow a desired flight path or may be flown by remote control. Additionally, the pre-retrofit IR thermography streams may be stored to a pre-retrofit IR thermography image repository. At a next step 508, the method texture maps the 3D building model with pre-retrofit IR images using GPS and pose metadata corresponding with the pre-retrofit IR images. At a next step, 510, the method identifies pre-retrofit anomalies, which step is discussed in further detail below for FIG. 7.

FIG. 7 is an illustrative flowchart 700 of methods for identifying anomalies in accordance with embodiments of the present invention. In particular, steps 702 and 704 further clarify a step 510 (see FIG. 5). In general, the identifying of anomalies is made possible by correlating the 3D model of the building with the IR thermographic images of the same building. As such, at a first step 702, the method selects a point or an area of interest on the 3D building model. In embodiments, this may be accomplished by a user clicking on a visually displayed 3D building model. At a next step 704, the method displays the pre-retrofit IR image corresponding with the point or area of the 3D model selected. Turning briefly to FIG. 11, selected area 1104 of the 3D building model and the corresponding IR image 1106 of the selected area are presented. At a next step 706, the method determines whether a retrofit has occurred. If the method determines at a step 706 that a retrofit has not occurred, the method ends.

FIG. 6 is an illustrative flowchart 600 methods for post-retrofit verification in accordance with embodiments of the present invention. In particular, flowchart 600 further clarifies a step 106 (see FIG. 1). At a first step 602 the method receives a post-retrofit IR thermography stream. Post-retrofit IR thermography streams are collected after a retrofitting operation in order to verify the installation or repair. As above, a post-retrofit IR thermography stream may be collected by a drone, which may be programmed to follow a desired flight path or may be flown by remote control. In addition, post-retrofit IR thermography streams may be stored to a post-retrofit IR thermography image repository. At a next step 604, the method texture maps the 3D building model with post-retrofit IR images using GPS and pose metadata corresponding with the post-retrofit IR images. At a next step, 606, the method identifies pre-retrofit anomalies, which step is discussed in further detail below for FIG. 7.

Returning to FIG. 7, steps 708 and 710 further clarify a step 606 (see FIG. 6). As such, if the method determines at a step 706 that a retrofit has occurred, the method continues to a step 708, the method displays the post-retrofit IR image corresponding with the point or area of the 3D model selected. At a next step 708, the method displays the post-retrofit IR image corresponding with the point or area of the 3D model selected similar to step 704 as illustrated in FIG. 11 where selected area 1104 of the building model and the corresponding IR image 1106 of the selected area are presented. At a next step 710, the method compares post-retrofit anomalies with pre-retrofit anomalies. In practice, the comparison is typically a visual comparison of the displayed IR thermography images. The method then ends.

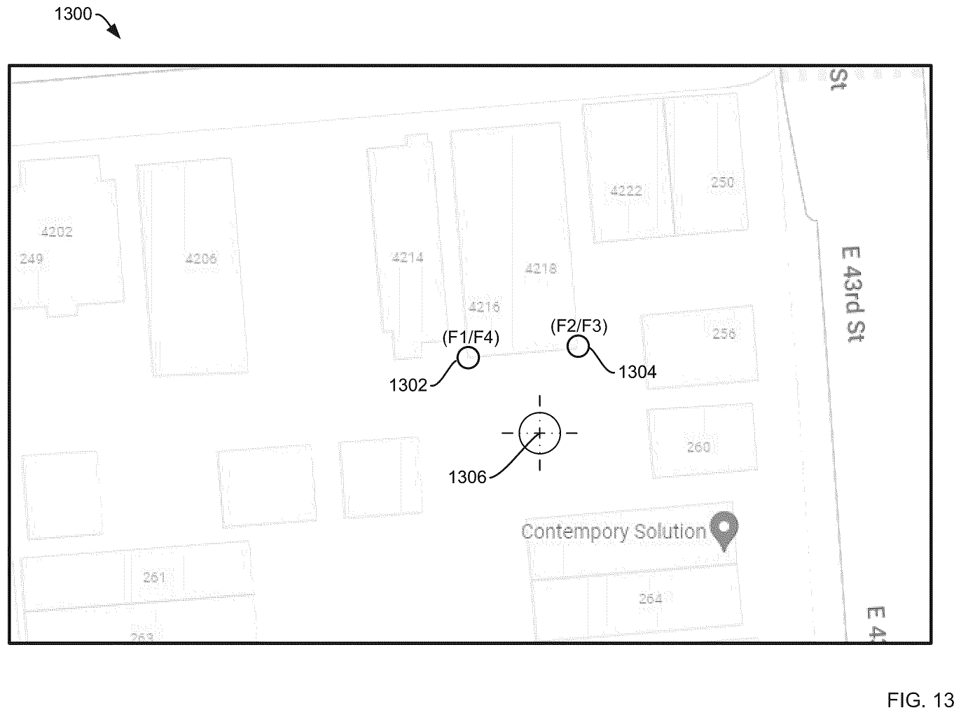

FIG. 8 is an illustrative flowchart of methods for recovering images in accordance with embodiments of the present invention. In particular, FIG. 8 further illustrates methods utilized in steps 404, 406, and 412 (FIG. 4), namely image recovery. As such, at a first step 802, the method selects corners of a façade of interest on an RGB panorama such as an RGB panorama created at a step 204 (see FIG. 2). Turning briefly to FIG. 12, which is an illustrative representation of a building façade on panorama 1200 in accordance with embodiments of the present invention. As illustrated, four façade corners are indicated, namely ground level façade corners F4 (1208) and F3 (1206) and roof level façade corners F1 (1202) and F2 (1204). These facade corners define a façade of interest. In embodiments, façade corners may be user or algorithmically selected. Once the façade corners are selected, the method looks up the pixel coordinate in the RGB panorama corresponding with each of the selected corners. Returning to FIG. 8, at a step 804, the method continues to find the ground level façade endpoints (i.e., F3 and F4) on a digital map. Turning FIG. 13, which is an illustrative representation of façade endpoints 1302 and 1304 on digital map 1300 in accordance with embodiments of the present invention. In particular, a top-down digital map view is provided. As illustrated, façade endpoint 1302 corresponds with façade roof level corner F1 and façade ground level façade corner F4, which are axially aligned. Likewise, façade endpoint 1304 corresponds with façade roof level corner F2 and façade ground level façade corner F3, which are axially aligned. The location 1306 of the drone or other recording device is also illustrated. Returning to FIG. 8, at a next step 806, the method determines the GPS coordinates of the digital map located endpoints that were found in a step 804. At a next step 808, the method estimates the building height. In one embodiment, the method selects a drone RGB image where the drone is located at approximately the same height as the façade. The height of the drone may then be extracted from metadata corresponding with that RGB image in order to approximate the facade's height. From the façade or building height estimate, the GPS coordinates of façade corners F1 and F2 that are not touching the ground may be determined.

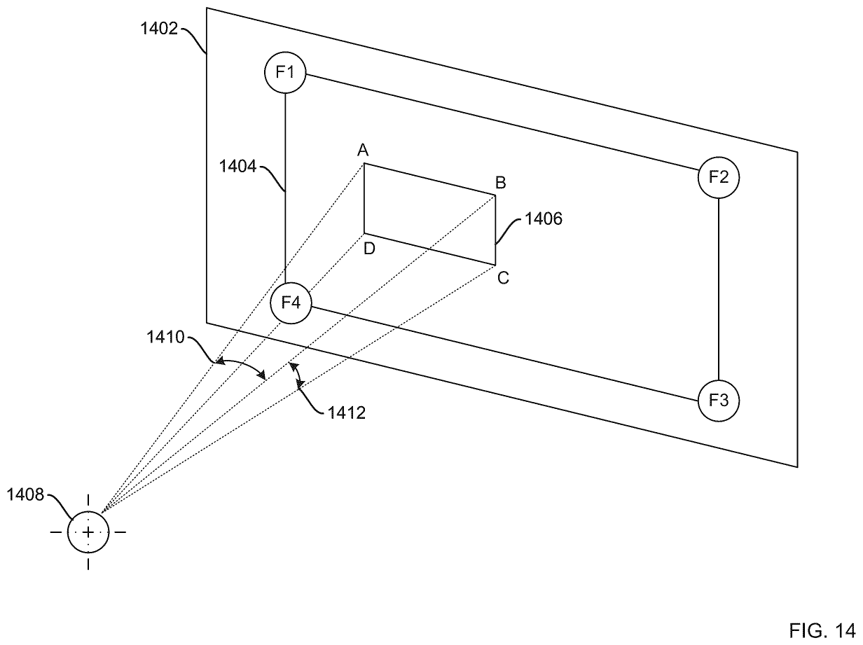

At a next step 810, the method computes an equation of the façade plane and its extent in the GPS coordinate system. Since the method can assume the facade to be perpendicular to the ground, knowing the height of the facade and the two ground level facade endpoints (i.e., F3 and F4) is enough to compute the equation of the façade plane in the GPS coordinate system. At a next step 812, the method projects all close view RGB images, all close view pre-retrofit IR images, and/or all close view post-retrofit images on the façade plane. For each of the close view RGB-IR image pairs, the drone's pose (location and orientation) can be retrieved from GPS and orientation metadata. Turning to FIG. 14, which is an illustrative representation of panorama 1402 having projected area 1406 on façade 1404 in accordance with embodiments of the present invention. Façade plane 1404 is defined by corners F1, F2, F3, and F4. Since the drone's camera's field of view (FOV) is known, using the drone pose and horizontal FOV 1410 and vertical FOV 1412, the method projects the footprint of the image from drone position 1408 onto the facade plane 1404 and therefore knows the area on the facade that a specific image captured. The method can then determine the GPS coordinates of the four corners of the projected area 1406 for the image on the façade plane shown as A, B, C, and D. Returning to FIG. 8, at a next step 814, the method computes pixel coordinates of the projected images. Pixel coordinate calculation of the projected image corners is accomplished utilizing at least the following:

The façade corners F1, F2, F3, F4 (see FIG. 14);

The pixel coordinates of the facade corners on the RGB panorama;

The GPS coordinates of the façade corners; and

The GPS coordinates of the projected image corners A, B, C, and D of the projected RGB/IR images on the façade plane.

The method continues to a step 816 to compute pixel coordinate of center of all projected images. This provides a single referent upon which to compare image location. At a next step 818, the method displays projected images having the pixel coordinate of center that substantially matches the selected point of the panorama at a step 402 (see FIG. 4A). Whereupon the method ends.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A method of retrofit analysis and verification for a building comprising:
analyzing a pre-retrofitted building;
performing a retrofit on the pre-retrofitted building; and
verifying the post-retrofitted building.

2. The method of claim 1, wherein the analyzing the pre-retrofitted building comprises:
receiving a long view red-green-blue (RGB) stream of the pre-retrofitted building and storing to an RGB image repository;
creating an RGB panorama of the pre-retrofitted building;
receiving a close view RGB stream of the pre-retrofitted building and storing to the RGB image repository;
receiving a close view pre-retrofit infrared (IR) thermography stream of the pre-retrofitted building and storing to a pre-retrofit IR image repository; and
identifying pre-retrofit anomalies of the pre-retrofitted building.

3. The method of claim 2, wherein the identifying the pre-retrofit anomalies comprises:
selecting a point on the RGB panorama;
recovering a close view RGB image corresponding with the selected point from the RGB image repository, wherein the close view RGB image is recovered using RGB image global positioning system (GPS) and pose metadata; and
recovering a close view pre-retrofit IR image corresponding with the selected point from the pre-retrofit IR image repository, wherein the close view pre-retrofit IR image is recovered using close view pre-retrofit IR image GPS and pose metadata; and
displaying the close view RGB image and the close view pre-retrofit IR image corresponding with the selected point.

4. The method of claim 3, further comprising:
superimposing the close view pre-retrofit IR image on the RGB panorama.

5. The method of claim 4 wherein the superimposing the close view pre-retrofit IR image on the RGB panorama comprises:
undistorting the close view pre-retrofit IR image;
selecting a plurality of close view pre-retrofit IR image correspondence points on the close view pre-retrofit IR image;
selecting a plurality of RGB panorama correspondence points on the RGB panorama corresponding with the plurality of close view pre-retrofit IR image correspondence points;
calculating a projected transformation between the close view pre-retrofit IR image and the RGB panorama such that pixels between the close view pre-retrofit IR image and the RGB panorama in the projected transformation are paired; and
replacing each paired RGB panorama pixel in the RGB panorama with a corresponding close view pre-retrofit IR image pixel in the projected transformation.

6. The method of claim 3, wherein the verifying the post-retrofitted building comprises:
receiving a close view post-retrofit IR thermography stream of the post-retrofitted building and storing to a post-retrofit IR image repository; and
identifying the post-retrofit anomalies.

7. The method of claim 6, wherein the identifying the post-retrofit anomalies comprises:
recovering a close view post-retrofit IR image corresponding with the selected point from the post-retrofit IR image repository, wherein the close view post-retrofit IR image is recovered using close view post-retrofit IR image GPS and pose metadata; and
displaying the close view RGB image, the close view pre-retrofit IR image, and the close view post-retrofit IR image; and
comparing the close view pre-retrofit IR image and the close view post-retrofit IR image to verify the post-retrofitted building.

8. The method of claim 7, further comprising:
superimposing the close view post-retrofit IR image on the RGB panorama.

9. The method of claim 8 wherein the superimposing the post-retrofit IR image on the RGB panorama comprises:
undistorting the close view post-retrofit IR image;
selecting a plurality of close view post-retrofit IR image correspondence points on the close view post-retrofit IR image;
selecting a plurality of RGB panorama correspondence points on the RGB panorama corresponding with the plurality of close view post-retrofit IR image correspondence points;
calculating a projected transformation between the close view post-retrofit IR image and the RGB panorama such that pixels between the close view post-retrofit IR image and the RGB panorama in the projected transformation are paired; and
replacing each paired RGB panorama pixel in the RGB panorama with a corresponding close view post-retrofit IR image pixel in the projected transformation.

10. The method of claim 7 wherein the recovering the close view RGB image, the close view pre-retrofit IR image, and the close view post-retrofit comprises:
selecting a plurality of façade corners that define a facade on the RGB panorama;
finding a plurality of façade endpoints corresponding with at least two of the plurality of façade corners on a digital map;
finding global positioning system (GPS) of the plurality of façade endpoints;
estimating a building height;
computing an equation of a façade plane;
projecting all close view RGB images, all close view pre-retrofit IR images, and all close view post-retrofit images on the façade plane;
computing pixel coordinates of the projected image corners of all projected images;
computing pixel coordinate of center of all projected images; and
displaying projected images having the pixel coordinate of center that substantially matches the selected point.

11. The method of claim 2, wherein
the RGB stream is captured by a first drone having a first flight path;
the close view pre-retrofit IR thermography stream is captured by a second drone having a second flight path; and
the close view RGB stream is captured by a third drone having a third flight path.

12. The method of claim 2, wherein
the close view RGB stream and the close view pre-retrofit IR thermography stream are captured by the second drone on the second flight path.

13. The method of claim 6, wherein
the close view post-retrofit IR thermography stream is captured by a fourth drone having a fourth flight path.

14. The method of claim 1, wherein the analyzing the pre-retrofitted building comprises:
receiving an RGB stream of the pre-retrofitted building and storing to an RGB image repository;
creating a 3D building model of the pre-retrofitted building using the RGB stream;
receiving a pre-retrofit IR thermography stream of the pre-retrofitted building and storing to a pre-retrofit IR image repository;
texture mapping the 3D building model with pre-retrofit IR images using GPS and pose metadata corresponding with the pre-retrofit IR images; and
identifying pre-retrofit anomalies of the pre-retrofitted building.

15. The method of claim 14, wherein the identifying the pre-retrofit anomalies comprises:
selecting a point or an area on the 3D building model; and
displaying the pre-retrofit IR image corresponding with the point or area of the 3D model.

16. The method of claim 15, wherein the verifying the post-retrofitted building comprises:
receiving a post-retrofit IR thermography stream of the post-retrofitted building and storing to a post-retrofit IR image repository;
texture mapping the 3D building model with post-retrofit IR images using GPS and pose metadata corresponding with the post-retrofit IR images; and
identifying post-retrofit anomalies of the post-retrofitted building.

17. The method of claim 16, wherein the identifying the post-retrofit anomalies comprises:
displaying the RGB image, the pre-retrofit IR image, and the post-retrofit IR image corresponding with the point or area of the 3D; and
comparing the pre-retrofit IR image and the post-retrofit IR image to verify the post-retrofitted building.

18. The method of claim 14, wherein
the RGB stream is captured by a first drone having a first flight path; and
the pre-retrofit IR thermography stream is captured by a second drone having a second flight path.

19. The method of claim 14, wherein
the RGB stream and the pre-retrofit IR thermography stream are captured by a first drone having a first flight path.

20. The method of claim 16, wherein
the post-retrofit IR thermography stream is captured by a third drone having a third flight path.
